(19) United States
(12) Patent Application Publication
(10) Pub. No.: US 2007/0297577 A1
(43) Pub. Date: Dec. 27, 2007

(54) SYSTEM AND METHOD FOR MAINTAINING COMMUNICATION RECORDING AUDIT TRAILS

(76) Inventor: Felix Immanuel Wyss, Bloomington, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/426,470

(22) Filed: Jun. 26, 2006

(51) Int. Cl. H04M 1/64

(52) U.S. Cl. 379/67.1

(57) ABSTRACT

A computer-implemented system and method for establishing an audit trail for a communication record in a contact center is provided. The central server maintains a log file associated with a communication record which contains a message digest, pertinent information, as well as a listing of all of the instances in which the record was accessed or changed. Additionally, the system and method implements recording access control and permissions to further ensure recording validity. When a user accesses a recording the system is automatically able to confirm the contents of the recording as original using the message digest and display each action that has been taken upon the current recording, including compression, modification, and any other associated information.

### FIELD OF THE INVENTION

The present invention generally relates to telecommunication systems and methods, as well as systems for monitoring communications. More particularly, the present invention pertains to a system and method for providing and maintaining trusted and secure communication recordings, including the functions of associating an audit trail with each recorded communication.

### BACKGROUND

Current telecommunication technology allows for the monitoring and recording of communications. In contact centers, supervisors utilize this capability to monitor agent performance and provide training in areas where a weakness is identified. However, most contact centers are unable to extract any value from these recorded communications going forward. Oftentimes, the recorded communications are therefore simply archived and subsequently ignored or deleted. Additionally, other telecommunication users, such as corporations may wish to records calls for compliance or other reasons.

For telecommunications users fortunate enough to effectively utilize recorded communications for other purposes, it is often difficult to establish the validity of the recorded communication and ensure that the information associated with the recording is accurate. Additionally, recordings are, by their digital nature, subject to editing such as addition, deletion, and/or rearrangement that may effectuate a meaningful change in their content.

The foregoing problems are demonstrably present in the telecommunications industry. For example, a telecommunications user often operates several offices that may provide callers with customer service, sales, voicemail, or other functions. The functions may relate to a product or service offered by the user or by another company. The user often generates a large quantity of recordings that may be stored locally or transferred to a server operated by the provider. These recordings may have future value as evidence to a customer of a prior communication or as training examples, but difficulties in ensuring the origin and validity of the recording may hinder their appropriate utilization.

### SUMMARY

Various technologies and techniques are disclosed for creating and maintaining an audit trail associated with a recording. A server receives a request to record an identified communication. After recording the communication, the system then programmatically generates an audit trail including a message digest and a message history log. The system may then utilize the message digest to verify the contents of the recording and also update the message history log with an action listing in response to each action taken with respect to its associated message.

In one embodiment, the message digest is a digital fingerprint such as a hash sum or some other summary or compact representation of a recording which changes with any modification to the original recording. The message history log is a sequential listing of the actions linked with the associated recording.

In a further embodiment, the message history log is a listing of actions taken on a recording, the user who performed the action, the device responsible for the action, and any other information related to the action. Representative actions may include, but are not limited to, the creation of a recording, playback of a recording, transfer of a recording from one storage point to another, deletion of segments of a recording, and the mixing of two recordings into one.

Yet other forms, embodiments, objects, advantages, benefits, features, and aspects of the present invention will become apparent from the detailed description and drawings contained herein.

This summary is provided to introduce a selection of concepts in a simplified form that are described in further detail in the detailed description and drawings contained herein. This Summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is a process flow diagram demonstrating one example of the stages involved in creating an audit trail in one embodiment of the present system and method.

FIG. 3 is a process flow diagram demonstrating one example of the stages involved in accessing or modifying a record having an associated audit trail in one embodiment of the present system and method.

FIG. 4 is a process flow diagram demonstrating one example of the stages involved in viewing an audit trail associated with a record in one embodiment of the present system and method.

FIG. 5 is a representative example of a screen shot showing the audit trail associated with a recording in accordance with one embodiment of the present system and method.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

One implementation includes a unique system and methods for creating and maintaining communication recording audit trails, such as in a contact center. It shall be understood that the principles of the present invention may also be applied to similar systems, such as by way of non-limiting example, a corporate telecommunication system.

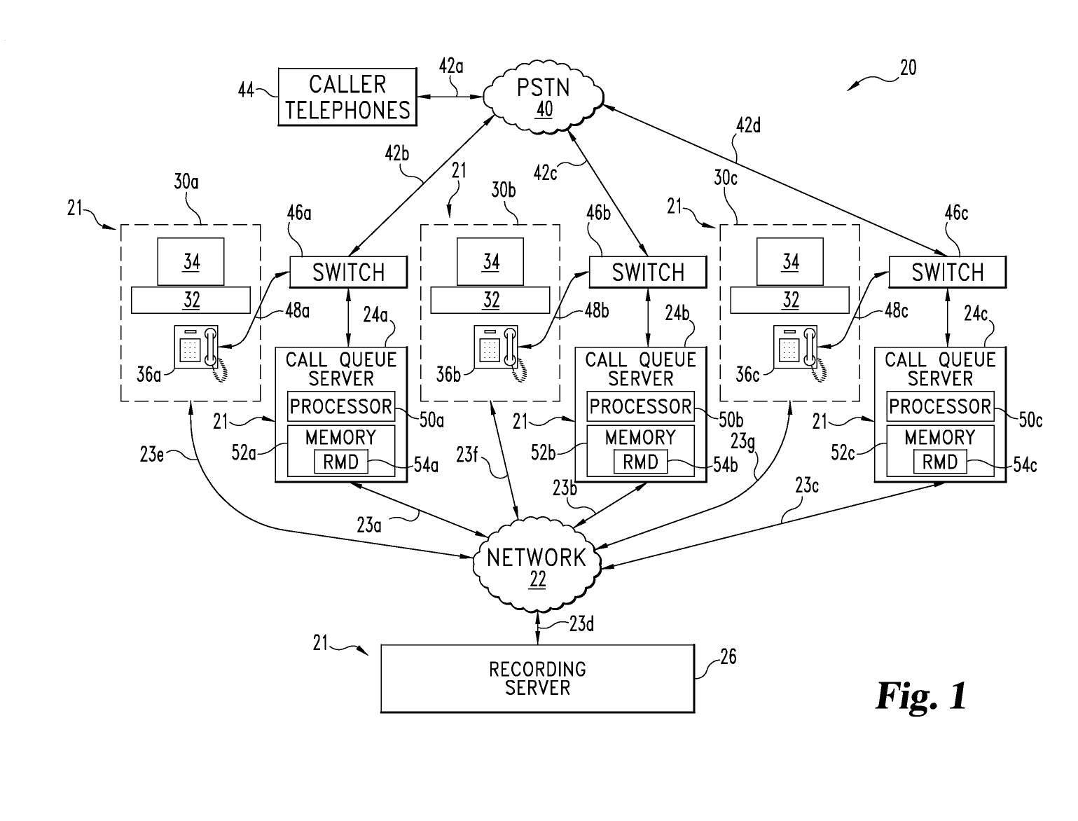

FIG. 1 is a diagrammatic view of computer system 20 of one embodiment of the present invention. Computer system 20 includes computer network 22. Computer network 22 couples together a number of computers 21 over network pathways 23. More specifically, system 20 includes several servers, namely Call Queue Servers 24a, 24b, and 24c, and a Recording Server 26. System 20 also includes agent client workstations 30a, 30b, and 30c. While computers 21 are each illustrated as being a server or client, it should be understood that any of computers 21 may be arranged to include both a client and server. Furthermore, it should be understood that while seven computers 21 are illustrated, more or fewer may be utilized in alternative embodiments.

Call Queue Servers 24a, 24b, and 24c and Recording Server 26 include one or more processors or CPUs (50a, 50b, 50c, and 50d, respectively) and one or more types of memory (52a, 52b, 52c, and 52d, respectively). Each memory 52a, 52b, 52c, and 52d includes a removable memory device (54a, 54b, 54c, and 54d, respectively). Although not shown to preserve clarity, each computer 21 of system 20 includes one or more processors or CPUs and one or more types of memory. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

System 20 further illustrates Public Switched Telephone Network (PSTN) 40 coupled to computer-controlled telephone switches 46a, 46b, and 46c (alternatively designated switches 46) of servers 24a, 24b, and 24c by pathways 42b, 42c, and 42d, respectively. Caller telephones 44 are coupled to PSTN 40 by pathway 42a. Switches 46 are also coupled to telephones 36a, 36b, and 36c (alternatively designated telephones 36) by pathways 48a, 48b, and 48c. For the sake of clarity, each switch 46 is shown coupled to a corresponding telephone 36. However, is should be understood that each of telephones 36 may be coupled to one or more switches and that switches 36 may be located at one or more physical locations. Switches 46 may be arranged in the form of a Private Branch Exchange (PBX), predictive dialer, Automatic Call Distributor (ACD), a combination of these, or another switching configuration as would occur to those skilled in the art. Telephones 36 may be in the form of a handset, headset, or other arrangement as would occur to those skilled in the art. Telephones 36a, 36b, and 36c are each associated with a different one of agent workstations 30a, 30b, and 30c, respectively (collectively designated agent workstations 30). Agent workstations 30 each include an agent computer 32 coupled to a display 34. Agent computers 32 may be of the same type, or a heterogeneous combination of different computing devices. Likewise, displays 34 may be of the same type, or a heterogeneous combination of different visual devices. Additionally, telephones 36 may be integrated into the agent computer 32 and/or implemented in software. Although not shown to preserve clarity, each agent workstation 30 may also include one or more operator input devices such as a keyboard, mouse, track ball, light pen, and/or microtelecommunicator, to name just a few representative examples. Also, besides display 34, one or more other output devices may be included such as loudspeaker(s) and/or a printer.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22. It should also be recognized that computer network 22 may include one or more elements of PSTN 40. Indeed, in an alternate embodiment, PSTN 40 and computer network 22 are provided as a common network.

In one embodiment, system 20 operates as a contact center at one or more physical locations that are remote from one another with Call Queue Servers 24a, 24b, and 24c being configured as contact center server hosts, Recording Server 26 being configured as a server for monitoring the scoring of agent communications, and agent workstations 30a, 30b, and 30c each arranged as a contact center client host. It shall be understood that one or more Recording Servers 26 may be included to handle the recording load in a contact center, but only one has been shown in FIG. 1 to preserve clarity. Additionally, the Recording Server 26 may be incorporated into another device or located in a geographically different location from switches 46.

Additional telephones 36 may be connected to switches 46 that each correspond to an additional client host to provide more agent workstations 30 (not shown). Typically contact center applications of system 20 would include many more agent workstations of this type at one or more physical locations, but only a few have been illustrated in FIG. 1 to preserve clarity. Also, one or more servers 24 may be configured as a contact center server host at one or more physical locations. Furthermore, one or more servers 24 may also be configured to provide, collectively or individually, the features of Recording Server 26 described herein.

Alternatively or additionally, system 20 may be arranged to provide for distribution and routing of a number of different forms of communication, such as telephone calls, voice mails, faxes, e-mail, web chats, instant messages, web call backs, and the like. Furthermore, business/customer data associated with various communications may be selectively accessed with system 20. This data may be presented to an agent at each agent workstation 30 by way of monitor 34 operatively coupled to the corresponding agent computer 32.

References herein to a communication recording shall be understood to include, by way of non-limiting example, a telephone call, any meta-data, screen captures, or signaling information associated with a communication, a voicemail, e-mail, instant message, video conference, or any other communication type known to one of skill in the art. Further, references to a telephone call in the illustrative embodiment shall be understood to include traditional PSTN calls and digital telephony such as VOIP, SIP, and SRTP to name just a few. The present system and method may be applied to many other types of communications and their use within the current system and method is desired to be protected.

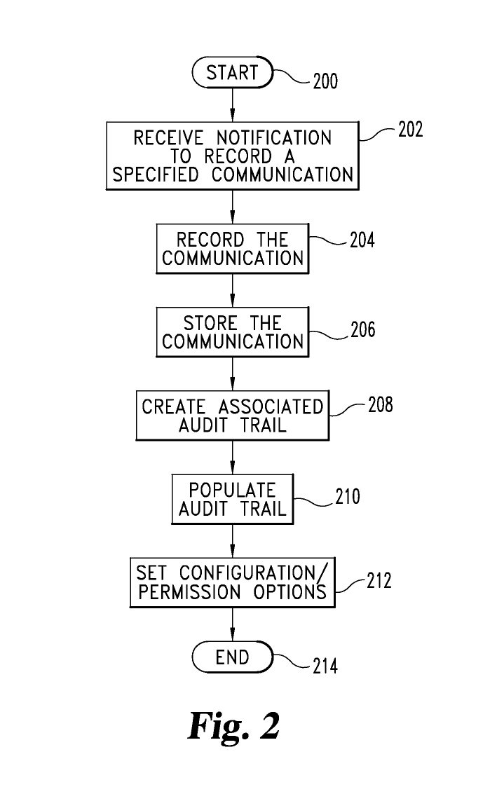

Turning now to FIG. 2, with continued reference to FIG. 1, the stages for associating an audit trail with a communication recording in one embodiment of the present system and method is shown. In one form, the process of FIG. 2 is at least partially implemented in the operating logic of system 20. The process begins at start point 200 with the Recording Server 26 receiving a notification to record a specified communication (stage 202). The notification may be received simultaneously as a communication is processed, or may occur before or after depending upon the operator's recording needs. In the illustrative embodiment, the notification includes information identifying the communication to be recorded as well as a set of configuration options. This identifying information may include the agent station on which the communication to be recorded will take place, a secure device fingerprint, a unique communication identifier, or any other identifier known to one of skill in the art. Additionally, the configurations options may include, but are in no way limited to, the amount of each communication to record, the method of storage for the communication, a selected recording format, and/or a storage location. In the illustrative embodiment, the communications are telephone calls between an agent in a call center and a third party which are recorded and stored for subsequent review. In a further embodiment, the system 20 is configured to allow the selective recording of each party to a communication individually for communication verification.

Once the communication has been identified and the configuration options received, the Recording Server 26 may proceed to record the communication (stage 204). In the illustrative embodiment, the communication is a telephone call which may be recorded using a variety of recording methods including voice recording utilizing the G.7111, TrueSpeech, or GSM format, screen capture recording, conference call recording, and call information recording. It shall be appreciated that a communication may be received in one format and recorded in another more favorable or suitable format. Additionally, the system 20 may notify the parties that the call may be recorded in a manner suitable to comply with legal requirements. Additionally, other communication methods, such as instant messaging, e-mail, and VOIP, may be recorded using techniques known to one of skill in the art.

After the Recording Server 26 records the designated communication, the system 20 stores the recording (stage 206). It shall be appreciated that the communication recording may be written to file during the course of the communication, depending upon the implementation. As determined by the configuration options, the recording may include either a subset of selected parties or a mixture of all parties to the communication and may also include only a selected portion of the communication. In the illustrative embodiment, the Recording Server 26 records each party to the communication individually to allow later verification of content. In one form, the recording may be stored on Recording Server 26 and may subsequently be transferred to the central server for archival. In another form, the recording may be compressed and transferred to a database or file server. In a further form, the recording may be encrypted as it is written to the file to preserve security. In yet another form, in the event of a spoken communication, language processing techniques or human transcription may be utilized to create and store a transcript of the recorded communication. In a still further form, multiple individual streams of the same communication may be preserved in various formats such as text and audio, or audio in varying degrees of compression.

Once the communication recording is established (stage 206), the Recording Server 26 creates an audit trail and associates it with the recorded communication (stage 208). In the illustrative embodiment, the audit trail includes a digest value and message history. In a preferred form, the digest value is a digital fingerprint such as a result of a cryptographically secure message authentication code, a hash sum, or some other summary or compact representation of a recording whose result detectably altered with even the slightest modification to the original recording. In a further embodiment, a unique digest value may be assigned to several sections of a recording, each having a predetermined length. Thus, the entire fingerprint would not have to be re-computed if only a small segment of the recording were to be modified.

In the illustrative embodiment, the message history is a sequential listing of the actions linked with the associated recording. In the preferred embodiment, the message history is a listing of every action taken on a recording and includes information related to each action. By way of non-limiting example, these actions may include the creation, compression, playback, editing, encryption, and deletion of a communication recording, as well as the mixing of two communication recordings, transfer of a communication recording from one storage point to another, or any other alteration such as silence removal, noise reduction, filtering, etc.

In the illustrative embodiment, once the audit trail has been created in stage 208, the Recording Server 26 may populate it with the recording's current information (stage 210). In a preferred embodiment, the digest value results from the application of a cryptographically secure message authentication code, such as the SHA algorithm, to at least a portion of the recorded communication. In one form, a new digest value is created and stored with each modification to the recording to ensure its originality. In another form, an original digest value is created after an optional compression stage and the original digest value is stored and never re-created. Thus, a user may verify the originality of the recording at any time by calculating a new digest value and comparing it with the original digest value stored in the audit trail.

In the illustrated embodiment, during stage 210, the Recording Server 26 also populates the message history. In a preferred embodiment, this process includes the addition of a recording creation entry along with the relevant information associated with the creation of the recording. For example, in one form, the creation entry may include the date and time of the communication, a unique identifier which identifies the device(s) that performed the recording, information from the initial notification indicating which entity or user requested the recording, or any other information relevant to the recording.

In another form, the creation entry may also include contact information about the participants of the recording (such as caller identification, phone number, IP address, e-mail address, screen name, etc.) or any other identifying information known to one of skill in the art. In a further form, the audit trail may include information such as a score assigned to performance of an agent who is a party to the associated recorded communication as well as other statistics known to one of skill in the art. Additionally, if the message were compressed, then the Recording server 26 may enter an appropriate compression entry identifying the date and time of compression, the algorithm used, and the device(s) responsible for the compression.

After the audit trail has been populated in stage 210, the system 20 may set a plurality of configuration options and/or permissions (stage 212). In a preferred embodiment, the system 20 may receive a predetermined time period which identifies how long the recording will remain in memory on the system 20. Thus, once the recording has been maintained for a fixed time period, for example 2 years, the system 20 will automatically delete the recording or designate it for archival to conserve valuable storage space. A further preferred form allows for recordings to be subject to higher compression as time goes by and the likelihood of needing the recoding diminishes, thereby conserving valuable storage space. In another form, the system 20 implements permission controls which enable only a select group of designated users within the system 20 to perform a set of actions on the recordings. In the illustrative embodiment, the system is configurable so that a hierarchical approach may be implemented in which contact center agents have no access to the recordings, supervisors are able to play back and/or view the recordings, and administrators are able to perform all actions associated with a recording including compression, deletion, and modification. In a preferred embodiment, a message digest may be created for the audit trail to ensure its validity, and the audit trail may also be encrypted to further prevent unauthorized access or disclosure. In one embodiment, a digest value may be calculated from the audit trail itself and used to confirm the audit trails integrity. In a further form, the digest value of an audit trail may be used to link the audit trail to its associated recording for rapid retrieval in a secure fashion. Other methods of user permission known to one of skill in the art may be applied to achieve the desired goals of limiting access to increase communication recording integrity. Once the optional permission and configuration options have been set, the process ends at end point 214. It shall be understood that any of the above mentioned steps could occur concurrently while the communication is still taking place.

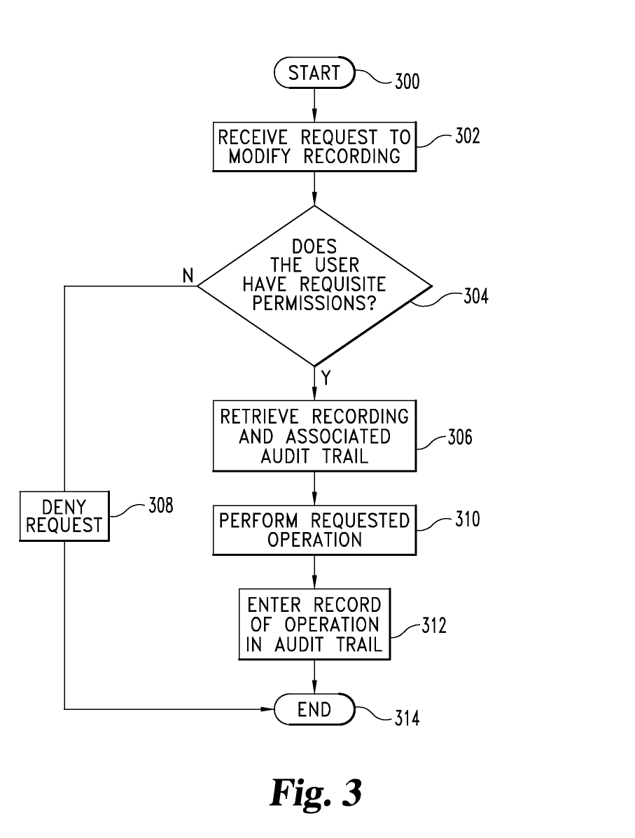

FIG. 3 illustrates one example of the stages involved in accessing or modifying a recording having an associated audit trail in one embodiment of the present system and method. The process begins at start point 300 with the Recording Server 26 receiving a request to modify a recording. Once the request is received, the Recording Server 26 retrieves the user/device profile associated with the requesting user/device and determines if the user/device possesses the requisite access level to modify the recording (stage 304). If the user/device does not have the requisite access level, such as a contact center supervisor who in the illustrative embodiment is only able to view a recording, or a device located at a non-verified site, then the Recording Server 26 denies the request (stage 308) and the process ends at end point 314. If the user/device does have the requisite permissions, then the Recording Server 26 retrieves the requested recording and associated audit trail (stage 306). Once the recording has been retrieved, the Recording Server 26 may execute one or more actions using the recording (stage 310). In the illustrative embodiment, these actions may include a request to redact the recording, a request to delete the recording, a request to merge two or more recordings into one, a request to run a filter, such as a background noise reducing filter on the recording, or a request to further compress the recording.

Once the requested operation has been performed (stage 310), the Recording Server 26 may include an entry in the message history of the audit trail (stage 312) that indicates what action was taken, when it was taken, who requested it, and any other information which may be relevant to the action. In one form, the Recording Server 26 may also calculate and assign a new message digest to the newly modified recording to ensure its validity back to the current point. The process ends at end point 314. It shall be understood that any Recording Server 26 may access a recording for further processing, even if it did not perform the initial recording.

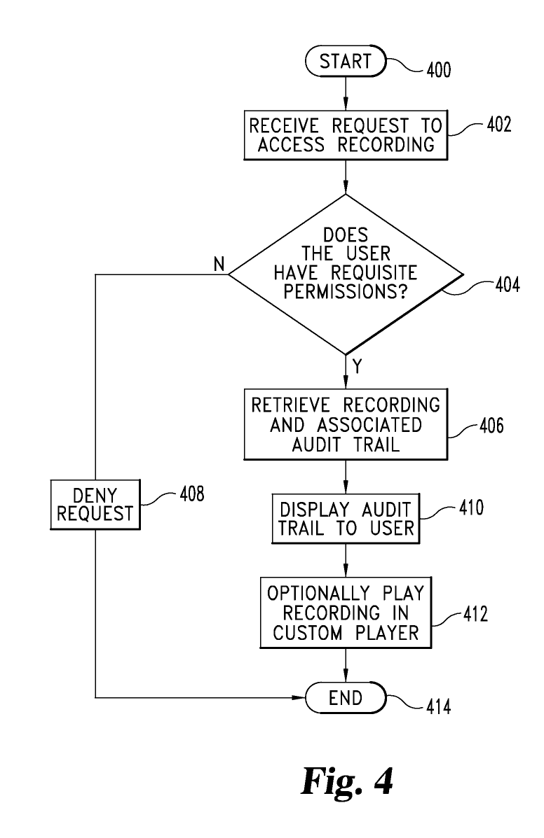

Turning now to FIG. 4, one example of the steps involved in the process of accessing a recording are shown. The process begins at start point 400 with the Recording Server 26 receiving a request to access a recording. Once the request is received, the Recording Server 26 retrieves the user/device profile associated with the requesting user/device and determines if the user/device possesses the requisite access level to access the recording (stage 404). If the user/device does not have the requisite access level, such as a contact center agent who in the illustrative embodiment is unable to view a recording, then the Recording Server 26 denies the request (stage 408) and the process ends at end point 414. If the user/device does have the requisite permissions, then the Recording Server 26 retrieves the requested recording and associated audit trail (stage 406). Once the recording has been retrieved, the Recording Server 26 may display the associated audit trail to the user/device (stage 410) and may also verify the digest value by calculating a new checksum using the same hash function to ensure that the digest value and new checksum match and that the recording is authentic. In one form, if the digest value does not match the new checksum, then an indication may be shown to the user before any action is taken with the unverified recording. Additionally, the Recording Server 26 may present the recording to the user in a custom player (stage 412) to provide convenient features and display of the associated attributes such as screen captures and agent information. In one form, the system may make a record of this viewing in the audit trail associated with the recording. The process ends at end point 414.

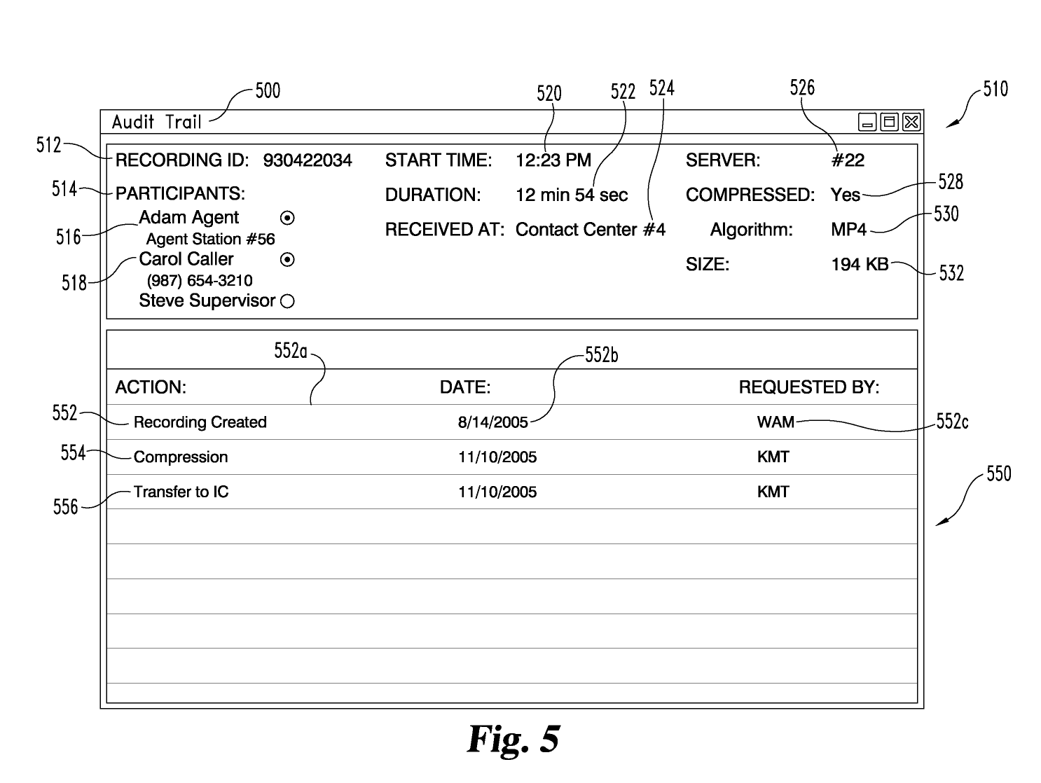

FIG. 5 is a representative example of a screen shot showing the audit trail associated with a recording in accordance with one embodiment of the present system and method. The audit trail 500 may be shown to any user having the requisite permissions upon request, or at any other time deemed necessary such as prior to playback. In the illustrative embodiment, audit trail 500 includes two main sections, general information section 510 and message history log 550. General information section 510 includes several fields having data derived from the associated recording. Field 512 includes the unique identifier assigned to the recording. In one form, this may be a unique name given to the recording, but in the illustrative embodiment, the recording is assigned a unique identifier, such as a sequential number, by the Recording Server 26.

Field 514 includes a listing of the participants to the recorded communication, for example, participants 516 and 518, and may also include the agent station or external phone number associated with each participant as determined by the system 20. In a further embodiment, field 516 and 518 may indicate whether or not the participant's communications appear in the recording. For instance, one recording may include only the agent's communications, but the third party may still well have been a participant in the communication. Additionally, the audit trail may include each party's contact information.

Field 520 indicates the time on which the communication associated with the recording began. Alternatively, field 520 may contain the time when recording began in the situation that only a portion of the communication is to be recorded. Field 522 indicates the duration of the recording, and may also indicate the duration of the communication if desired. Field 524 indicates the location to which the communication was received or originated from. For example, this may be an agent station at a contact center. Field 526 indicates the server which recorded the communication, such as Recording Server 26. Field 528 indicates if the recording was compressed and field 530 indicates which, if any, compression format was utilized to compress the recording. Field 532 indicates the size of the recording on disk, for example, in kilobytes (KB).

Message history log 550 contains a sequence of action listings, such as listing 552, which may indicate an individual action that was performed on the associated recording. For instance, action listing 552 shows the creation of the associated recording 552a, the time the action was taken 552b, and the user who requested the action 552c. If the user selects the listing, the system 20 may display a secondary screen to the user displaying more detailed information concerning the selected listing. Similarly, message history log 550 shows a plurality of other action listings such as action listing 554 showing a compression of the recording, action listing 556 showing a transfer of the recording to the central contact center server, and action listing 558 showing a playback of the recording.

In another embodiment, the system 20 may be configured within an existing telecommunication system, such as a corporate telecommunications network. The system 20 may operate to record any communication, whether incoming, outgoing or internal, which travels across the network. This may include incoming calls, voicemails, intra-office calls, faxes, and any other form of communication know to one of skill in the art.

In a further embodiment, the system 20 may be configured to extend permission to endpoints such as a VOIP enabled telephone to create and modify audit trails. In a preferred embodiment, voicemails would each be associated with a customized audit trail to ensure message authenticity and allow for message verification. Thus, a trusted endpoint, such as a VOIP enabled phone, would be able to establish an audit trail and create the appropriate entries into the message history upon transmission or receipt.

In yet a further embodiment, the system 20 may be configured to accept incoming calls and directly connect them to an automated response system. For example, an interactive voice response unit may be adapted to receiving information relative to a financial transaction such as a bank transfer, a stock order, or a bill payment, to name just a few representative examples. The current system and method would then allow the operator of system 20 to validate the communication that took place between the system and the caller in the event of a dispute.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A method comprising the steps of:
recording a communication, having at least a first party, to create a communication recording;
establishing an electronic audit trail which corresponds to said communication recording, said audit trail stored on a server;
calculating a digest value as a function of at least a portion of said communication recording; and
recording information about at least one action executed upon said communication recording to said audit trail.

2. The method of claim 1 further comprising the step of:
providing an authorized user access to said audit trail.

3. The method of claim 2, wherein said user is authorized to view only a portion of said audit trail.

4. The method of claim 1, wherein said actions are selected from the group consisting of:
the creation of a communication recording,
the compression of a communication recording,
the play back a communication recording,
the editing of a communication recording,
the encryption of a communication recording,
the deletion of a communication recording, and
the mixing of at least two communication recordings.

5. The method of claim 4, wherein said audit trail includes information about which entity initiated at least one of said actions.

6. The method of claim 4, wherein said audit trail includes information identifying which device performed at least one of said actions.

7. The method of claim 1, wherein said audit trail includes information about said first party.

8. The method of claim 7, wherein said audit trail includes the name and contact information associated with said first party.

9. The method of claim 7, wherein said audit trail indicates if the communication of said first party is included in said communication recording.

10. The method of claim 7, wherein said audit trail includes information about at least one or more additional parties associated with said communication recording.

11. The method of claim 1, wherein said audit trail includes the start time and duration of said communication.

12. The method of claim 1, wherein said audit trail includes information identifying the recording format of said communication recording.

13. The method of claim 1, wherein said communication recording is encrypted.

14. The method of claim 13, wherein said audit trail includes information identifying the server upon which said communication recording was encrypted.

15. The method of claim 1, wherein said message digest is calculated upon the entire message.

16. The method of claim 1, wherein a plurality of digest values is created in association with segments of said communication recording.

17. The method of claim 1 further comprising the steps of:
creating a second digest value as a function of said audit trail; and
associating said communication recording and said audit trail using said digest value and said second digest value.

18. The method of claim 1, wherein said communication recording includes signaling received from a party to said communication.

19. The method of claim 1, wherein said audit trail includes meta-data associated with said communication.

20. The method of claim 19, wherein said meta-data includes a list of devices involved in processing said communication.

21. The method of claim 20, wherein said devices are identified by their associated Internet Protocol addresses.

22. The method of claim 20, wherein the plurality of operations performed by said devices is included in said list.

23. The method of claim 1, wherein said communication recording includes screen captures.

24. The method of claim 1, wherein said audit trail includes a transcript of said communication recording.

25. The method of claim 24, wherein said transcript is computer generated.

26. The method of claim 1, wherein said audit trail includes a scoring assessment of said associated communication recording.

27. The method of claim 1, wherein said communication recording is automatically subject to increased compression as it ages.

28. The method of claim 1, wherein said calculating includes utilizing a cryptographically secure message authentication code.

29. The method of claim 28, wherein said message authentication code is the SHA algorithm.

30. A computer system for providing an audit trail comprising the operations of:
receiving a plurality of communication recordings, each said communication recording having a first party; and
creating a respective audit trail for each of said communication recordings, said audit trail comprising:
a digest value calculated as a function of at least a portion of said communication recording; and
a chain of records identifying a set of actions taken on said communication recording.

31. The computer system of claim 30 further comprising the step of:
automatically confirming whether said communication recording is authentic or not based upon said digest value.

32. The computer system of claim 30, wherein said communication recording includes signaling events.

33. The computer system of claim 30, wherein said communication recording includes screen captures from said first party.

34. The computer system of claim 30, wherein said audit trail includes meta-data associated with said communication.

35. The computer system of claim 30, wherein said audit trail includes a transcript of the associated communication recording.

36. The computer system of claim 30, wherein said audit trail includes statistics based on said communication.

37. The computer system of claim 30, wherein said audit trail is encrypted.

38. A method for verifying at least a portion of a recorded communication comprising the steps of:
retrieving an audit trail corresponding to said portion, said audit trail including a first digest value;
computing a second digest value as a function of said portion;
confirming whether said portion is authentic or not by comparing said first digest value to said second digest value.

39. The method of claim 38, wherein said audit trail is linked to said portion by their respective digest values.

40. The method of claim 38, wherein said second digest value is calculated using a cryptographically secure message authentication code.

41. The method of claim 38, wherein said second digest value is computed using the SHA algorithm.

42. The method of claim 38, wherein said retrieving includes the step of:
decrypting said audit trail.
